(19) United States
(12) Patent Application Publication
(10) Pub. No.: US 2024/0416968 A1
(43) Pub. Date: Dec. 19, 2024

(54) VEHICLE CONTROL DEVICE

(71) Applicant: TOYOTA JIDOSHA KABUSHIKI KAISHA, Toyota-shi (JP)

(72) Inventor: Haruki OGURI, Toyota-shi (JP)

(73) Assignee: TOYOTA JIDOSHA KABUSHIKI KAISHA, Toyota-shi (JP)

(21) Appl. No.: 18/674,365

(22) Filed: May 24, 2024

(30) Foreign Application Priority Data
Jun. 13, 2023 (JP) 2023-096983

(51) Int. Cl. B60W 60/00; G05D 1/225; G05D 1/227

(52) U.S. Cl. CPC B60W 60/005; G05D 1/225; G05D 1/2274; B60W 2520/04

(57) ABSTRACT

The vehicle control device is a vehicle control device connected between an autonomous driving system and a vehicle platform that performs automated driving in accordance with a command from the autonomous driving system, and includes a memory in which a program including a predetermined API defined for each signal is stored, and a processor that controls the vehicle platform in response to the command from the autonomous driving system by executing the program. The vehicle control device has a manual driving mode and an automatic driving mode as vehicle modes. The vehicle platform is capable of receiving a manual driving operation in the manual driving mode, and is capable of receiving a driving command from the autonomous driving system in the automatic driving mode. The processor prohibits the transition from the automatic driving mode to the manual driving mode on condition that the vehicle platform is not stopped.

### CROSS-REFERENCE TO RELATED APPLICATION

This application claims priority to Japanese Patent Application No. 2023-096983 filed on Jun. 13, 2023, incorporated herein by reference in its entirety.

### BACKGROUND

### 1. Technical Field

This disclosure relates to a vehicle control device, and particularly to a vehicle control device connected between an autonomous driving system and a vehicle platform that performs autonomous driving according to an instruction from the autonomous driving system.

### 2. Description of Related Art

There has been a system in which a vehicle and an information processing device cooperate to execute autonomous driving (see Japanese Unexamined Patent Application Publication No. 2019-177807 (JP 2019-177807 A), for example). In this system, the information processing device automatically generates control information using autonomous driving control software, and transmits the control information to the vehicle. The vehicle executes autonomous driving based on the received control information.

### SUMMARY

In the vehicle capable of autonomous driving in the system according to JP 2019-177807 A, it is unclear whether a driver can appropriately handle a transition to manual driving during traveling. Therefore, there is an issue of appropriately switching to manual driving.

The present disclosure has been made in order to address the above-described issue, and an object thereof is to provide a vehicle control device capable of appropriately switching to manual driving.

An aspect of this disclosure provides a vehicle control device connected between an autonomous driving system and a vehicle platform that performs autonomous driving according to an instruction from the autonomous driving system, including:

a memory that stores a program that includes a predetermined application program interface (API) defined for each signal; and
a processor that controls the vehicle platform according to the instruction from the autonomous driving system by executing the program.
The vehicle control device includes a manual driving mode and an autonomous driving mode as vehicle modes.
The vehicle platform is capable of
receiving a manual driving operation in the manual driving mode, and
receiving a driving instruction from the autonomous driving system in the autonomous driving mode.
The processor prohibits a transition from the autonomous driving mode to the manual driving mode on condition that the vehicle platform is not stopped.

According to such a configuration, a transition is not made from the autonomous driving mode to the manual driving mode in a state that it is difficult for a driver to appropriately handle, such as when the vehicle platform is not stopped. Therefore, it is possible to make a transition from the autonomous driving mode to the manual driving mode in a state that it is easy for a driver to appropriately handle. As a result, it is possible to provide a vehicle control device capable of appropriately switching to manual driving.

The processor may transition from the autonomous driving mode to the manual driving mode on condition that the vehicle platform has become immobile when an emergency stop switch is operated.

According to such a configuration, a transition can be made to the manual driving mode when the vehicle platform has reliably been rendered immobile in the autonomous driving mode in response to an operation of the emergency stop switch. As a result, it is possible to switch to manual driving more appropriately.

The processor may permit a transition to the autonomous driving mode on condition that the vehicle platform is activated from a state of being not activated when a transition is made to the manual driving mode.

According to such a configuration, when a transition is made from the autonomous driving mode to the manual driving mode, a transition to the autonomous driving mode can be rendered possible once the vehicle platform is brought into a state of being not activated. As a result, it is possible to suppress a transition from the manual driving mode to the autonomous driving mode in an abnormal state in which the vehicle platform cannot be activated again.

The vehicle platform may be further capable of autonomous driving according to an instruction from a remote driving system; and

the processor may
control the vehicle platform according to the instruction from the remote driving system by executing the program, and
transition from the autonomous driving mode to the manual driving mode on condition that the vehicle platform has become immobile when the processor is unable to receive the instruction from the remote driving system.

According to such a configuration, when autonomous driving according to the instruction from the remote driving system has become impossible, a transition can be made to the manual driving mode when the vehicle platform has reliably been rendered immobile in the autonomous driving mode. As a result, it is possible to appropriately switch to manual driving even when remote driving is performed.

The processor may transition from the autonomous driving mode to the manual driving mode on condition that the vehicle platform has become immobile when the emergency stop switch is operated when the processor is unable to receive the instruction from the remote driving system.

According to such a configuration, when remote driving is performed, a transition can be made to the manual driving mode when the vehicle platform has reliably been rendered immobile in the autonomous driving mode in response to an operation of the emergency stop switch. As a result, it is possible to switch to manual driving further appropriately even when remote driving is performed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an outline of a vehicle according to an embodiment of the present disclosure;

FIG. 2 is a more detailed view of the configuration of ADS, 0 and VP;

FIG. 3 is a state transition diagram for explaining the vehicle mode in this embodiment;

FIG. 4 is a diagram illustrating transmission directions of various signals or commands related to transitions between modes; and

FIG. 5 is a state transition diagram of the integrated control manager when the emergency stop switch is operated.

### DETAILED DESCRIPTION OF EMBODIMENTS

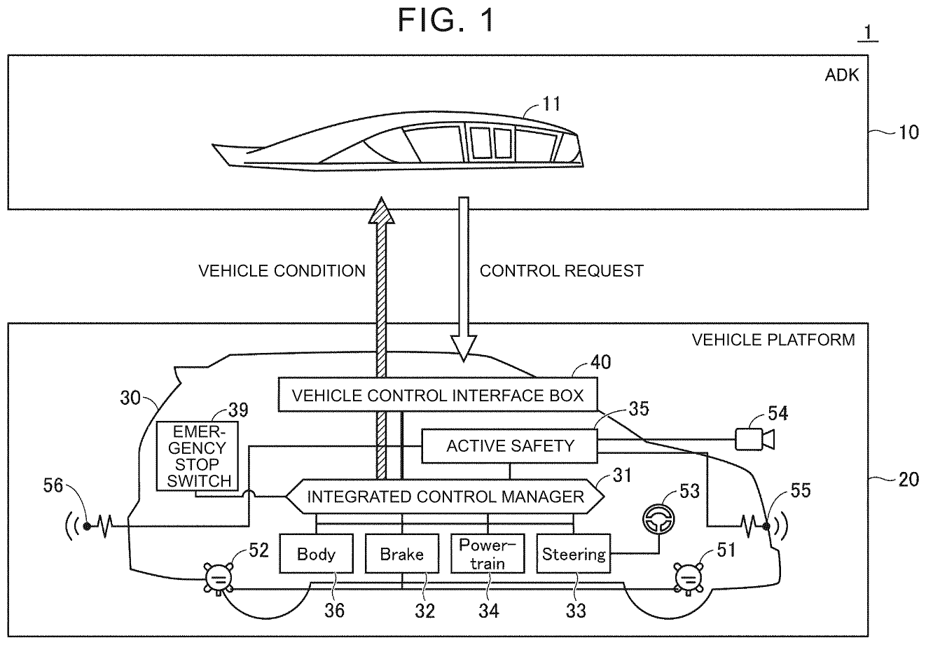

FIG. 1 is a diagram illustrating an outline of vehicles according to an embodiment of the present disclosure. The vehicle 1 includes an Autonomous Driving Kit (ADK) 10 and a vehicle platform (VP) 20. ADK 10 is configured to be attachable to VP 20 (mountable to the vehicles 1). ADK 10 and VP 20 are configured to be able to communicate with each other via a vehicle-control interface (a VCIB 40 described later).

VP 20 can perform autonomous driving in accordance with control demands from ADK 10. In FIG. 1, although ADK 10 is shown at a position away from VP 20, ADK 10 is actually attached to a rooftop or the like of VP 20. ADK 10 can also be removed from VP 20. When ADK 10 is removed, VP 20 performs travel control (travel control according to user manipulation) in the manual mode.

ADK 10 includes an autonomous driving system (ADS) 11) for performing autonomous driving of the vehicles 1. ADS 11 creates, for example, a travel plan of the vehicles 1. ADS 11 outputs various control requests for causing the vehicle 1 to travel in accordance with the travel plan to VP 20 in accordance with an Application Program Interface (API defined for each control request. Further, ADS 11 receives various signals indicating the vehicle state (VP 20 state) from VP 20 according to an API defined for each signal. Then, ADS 11 reflects the condition of the vehicle in the travel plan.

VP 20 includes a base-vehicle 30 and a Vehicle Control Interface Box (VCIB) 40. The base vehicle 30 executes various types of vehicle control in accordance with control demands from ADK 10 (ADS 11). The base vehicle 30 includes various systems and various sensors for controlling the base vehicle 30. More specifically, the base vehicle 30 includes an integrated control manager 31, a brake system 32, a steering system 33, a powertrain system 34, an active safety system 35, a body system 36, wheel speed sensors 51 and 52, a pinion angle sensor 53, a camera 54, and radar sensors 55 and 56.

The integrated control manager 31 includes a processor and a memory, and integrates and controls the respective systems (the brake system 32, the steering system 33, the powertrain system 34, the active safety system 35, and the body system 36) related to the operation of the vehicle 1.

The brake system 32 is configured to control a braking device provided on each wheel of the base vehicle 30. The wheel speed sensors 51 and 52 are connected to the brake system 32. The wheel speed sensors 51 and 52 detect the rotational speeds of the front and rear wheels of the base vehicle 30, respectively, and output the detected rotational speeds to the brake system 32. The brake system 32 outputs the rotational speed of the wheels to VCIB 40 as one of the information included in the vehicle state. In addition, the brake system 32 generates a braking command for the braking device in accordance with a predetermined control demand outputted from ADS 11 via VCIB 40 and the integrated control manager 31. The brake system 32 controls the braking device using the generated braking command.

The steering system 33 is configured to be able to control the steering angle of the steered wheels of the vehicle 1 by using a steering device. A pinion angle sensor 53 is connected to the steering system 33. The pinion angle sensor 53 detects a rotation angle (pinion angle) of the pinion gear connected to the rotation shaft of the actuator, and outputs the detected rotation angle to the steering system 33. The steering system 33 outputs the pinion angle to VCIB 40 as one of information included in the vehicle status. In addition, the steering system 33 generates a steering command for the steering device in accordance with a predetermined control request outputted from ADS 11 via VCIB 40 and the integrated control manager 31. The steering system 33 controls the steering device by using the generated steering command.

The powertrain system 34 controls an Electric Parking Brake (EPB) system 341 on at least one of a plurality of wheels, a P-Lock system 342 on a transmission of the vehicle 1, and a propulsion system 343 including a shifting device configured to select a shift range.

The active safety system 35 uses the camera 54 and the radar sensors 55 and 56 to detect obstacles (pedestrians, bicycles, parked vehicles, utility poles, and the like) in the front or rear. The active safety system 35 determines whether the vehicle 1 is likely to collide with an obstacle based on the distance between the vehicle 1 and the obstacle and the moving direction of the vehicle 1. When the active safety system 35 determines that there is a possibility of a collision, it outputs a braking command to the brake system 32 via the integrated control manager 31 so that the braking force increases.

The body system 36 is configured to control components such as a direction indicator, a horn, a wiper, and the like according to, for example, a traveling state or an environment of the vehicle 1. The body system 36 controls the above-described components according to predetermined control requirements outputted from ADS 11 via VCIB 40 and the integrated control manager 31.

VCIB 40 is configured to be able to communicate with ADS 11 through Controller Area Network (CAN) or the like. VCIB 40 executes a predetermined API defined for each signal, and thereby receives various control requests from ADS 11 and outputs the vehicle status to ADS 11. When receiving the control request from ADK 10, VCIB 40 outputs a control command corresponding to the control request to the control command via the integrated control manager 31. Further, VCIB 40 acquires various types of information of the base vehicle 30 from various systems via the integrated control manager 31, and outputs the state of the base vehicle 30 as a vehicle state to ADS 11.

The base vehicle 30 further includes an emergency stop switch 39. The emergency stop switch 39 is provided so as to be operable by the driver of the vehicle 1, and when operated, outputs a signal indicating that the vehicle has been operated to the integrated control manager 31.

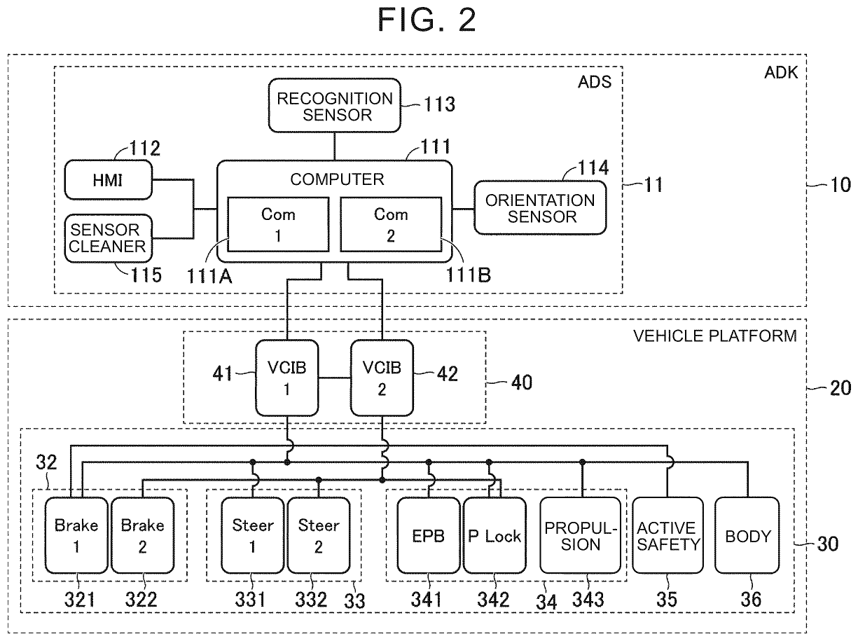

FIG. 2 is a diagram illustrating the configuration of ADS 11, VCIB 40 and VP 20 in more detail. As shown in FIG. 2, ADS 11 includes a computer 111, a Human Machine Interface (HMI) 112, a recognition sensor 113, an attitude sensor 114, and a sensor cleaner 115.

The computer 111 acquires the environment of the vehicle 1, the attitude, the behavior, and the position of the vehicle 1 using various sensors during the automated driving of the vehicle 1, and acquires the vehicle state from VP 20 through VCIB 40 to set a subsequent operation (acceleration, deceleration, bending, and the like) of the vehicle 1. The computer 111 outputs various commands for realizing the following operations to VCIB 40. The computer 111 includes a communications modular 111A, 111B. Each of the communication modular 111A, 111B is configured to be capable of communicating with a VCIB 40.

HMI 112 presents information to the user or accepts a user operation at the time of autonomous driving, driving requiring a user operation, transitioning between autonomous driving and driving requiring a user operation, and the like.

The recognition sensor 113 is a sensor for recognizing the environment of the vehicle 1. The recognition sensor 113 includes at least one of a Laser Imaging Detection and Ranging (LIDAR), a millimeter-wave radar, and a camera.

The attitude sensor 114 is a sensor for detecting the attitude, behavior, and position of the vehicle 1. The attitude sensor 114 includes, for example, Inertial Measurement Unit (IMU) and Global Positioning System (GPS). The sensor cleaner 115 is configured to remove dirt adhering to the various sensors (a lens of a camera, an irradiation unit of a laser beam, or the like) while the vehicle 1 is traveling by using a cleaning liquid, a wiper, or the like.

VCIB 40 includes a main VCIB 41 and a sub-part VCIB 42. Each of VCIB 41, 42 includes a processor, such as Central Processing Unit (CPU), and memories, such as Read Only Memory (ROM) and Random Access Memory (RAM). The memory stores a program executable by the processor. VCIB 41 and the communication modular 111A are communicably connected to each other. VCIB 42 and the communication modular 111B are communicably connected to each other. Further, VCIB 41 and VCIB 42 are communicably connected to each other.

Each of VCIB 41, 42 relays control requirements and vehicle-information between ADS 11 and VP 20. More specifically, VCIB 41 uses API to generate a control command from a control demand from ADS 11. Then, VCIB 41 outputs the generated control command to the corresponding system among the plurality of systems included in VP 20. VCIB 41 uses API to generate information indicating the vehicle status from the vehicle information from the respective systems of VP 20. VCIB 41 outputs the generated information indicating the vehicle-state to ADS 11. The same applies to VCIB 42.

EPB device 341 controls EPB according to a control request outputted from ADS 11 via VCIB 41. EPB is provided separately from the braking device (e.g., disc brake system) and fixes the wheels by operation of the actuator.

P-Lock device 342 controls ADS 11 according to a control request outputted from VCIB 41. P-Lock device 342 activates P-Lock device, for example, if the control request includes a control request that puts the shift range in the parking range (P range), and deactivates P-Lock device if the control request includes a control request that puts the shift range other than the P range. P-Lock device fixes the rotation of the output shaft of the transmission and fixes the wheels.

The propulsion system 343 switches a shift range of the shifting device and controls a driving force from a driving source (motor generator, engine, or the like) in accordance with a control request outputted from ADS 11 via VCIB 41.

In the vehicle 1, for example, the autonomous driving is executed when a later-described autonomous driving mode is selected in response to a request from ADK 10. As described above, ADS 11 first creates a travel plan during the automated driving. Examples of the travel plan include a plan for continuing straight travel, a plan for turning left/right at a predetermined intersection in the middle of a predetermined travel route, a plan for changing a travel lane, and the like. ADS 11 calculates a control physical quantity (acceleration, deceleration, tire-out angle, and the like) required for the vehicle 1 to operate in accordance with the created travel plan. ADS 11 divides the physical quantity for each API run cycle. ADS 11 uses API to provide control demands to VCIB 40 that represent the divided physical quantities. Further, ADS 11 acquires a vehicle state (an actual moving direction of the vehicle 1, a state of fixing of the vehicle, and the like) from VP 20, and re-creates a travel plan reflecting the acquired vehicle state. In this way, ADS 11 enables automated driving of the vehicles 1.

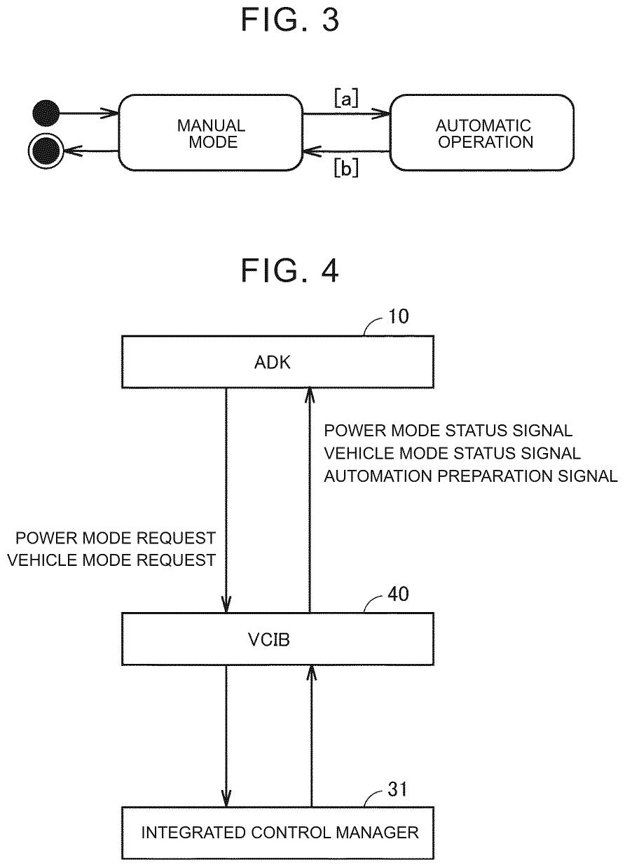

FIG. 3 is a state transition diagram illustrating a vehicle-mode transition. In this example, the vehicle 1 has a manual mode and an automatic driving mode as vehicle modes.

The manual mode is a mode similar to a vehicle that does not support autonomous driving, that is, a mode in which VP 20 is controlled by the driver. In the manual mode, ADK 10 is basically unable to control VP 20 except for some requirements.

The autonomous driving mode is a mode in which VP 20 is under the control of ADK 10 and the autonomous driving of the vehicles 1 is enabled. In the autonomous driving mode, ADK 10 can communicate with VP 20 after VCIB 40 has successfully authenticated ADK 10. In the autonomous driving mode, VP 20 is under the control of ADK 10 as a Vehicle Mode Command (described below) issued “Request for Autonomy”.

In the manual mode, Power mode status is “Wake” or “Driving Mode”. Vehicle mode state is “manual mode”. In the autonomous driving mode, Power mode status is “Driving Mode”. Vehicle mode state is an “autonomous driving mode”.

FIG. 4 is a diagram illustrating a transmission direction of various signals or commands related to transitions between modes. Upon mode-transition, VCIB 40 receives Power mode command and Vehicle Mode Command from ADK 10 (ADS 11). Further, VCIB 40 outputs Power mode status signal, Vehicle mode state signal, and Readiness for autonomization to ADK 10.

Power mode command is a requirement for controlling the power supply mode of VP 20. Power mode status signal is a signal indicating a present power supply mode status of VP 20. In the vehicle 1, API from ADS 11 to VCIB 40 transmits a Power mode command to control the power supply mode of VP 20. VP 20 according to this embodiment has two power supply modes, a Wake and a Driving Mode, as power supply modes.

In Wake, VCIB 40 is activated by power supplied from an auxiliary battery in the vehicle. In Wake, there is no power supply from the main engine battery, and ECU other than VCIB 40 are not activated except for a part of the body system ECU of the body system 36 (for example, a verification ECU for checking a smart key, a body ECU for controlling locking/unlocking of a door, and the like).

Driving Mode is a state in which VP 20 is powered on (a state in which the vehicular power is turned on). In Driving Mode, power is supplied from the main battery, VCIB 40 and the base-vehicle 30 are activated, and VP 20 is ready to travel.

Power mode command can have any of the values 0, 2, and 6. A value of 0 is set when ADS 11 does not request VP 20 power mode. If VCIB 40 receives a Power mode command with a value-0 set, VP 20 maintains its current power mode. Value-2 is set when requesting Wake from ADS 11. That is, in Power mode command where the value-2 is set, the activation of VCIB 40 is requested. When Power mode command with the value-2 set is received by VCIB 40, VP 20 is powered Wake, and VCIB 40 is activated by receiving power from the auxiliary battery. Value-6 is set when requesting Driving Mode from ADS 11. That is, in Power mode command where the value-6 is set, the activation of VP 20 is requested. When VCIB 40 receives Power mode command with the value-6 set, the power mode of VP 20 transitions to Driving Mode and VP 20 is powered on.

In the vehicle 1, a signal indicating the state of the power supply mode is transmitted from VCIB 40 to ADS 11 in accordance with a predetermined API, whereby the state of the power supply mode of VP 20 is notified to ADS 11. Power mode status sent to ADS 11 may take on any of the values 2 and 6. Value-2 is set when the power supply mode is Wake. Value-6 is set when the power supply mode is Driving Mode.

In the vehicle 1, API from ADS 11 to VCIB 40 transmits a Vehicle Mode Command to control the vehicle mode of VP 20. Vehicle Mode Command may take any of the values 0-2 in the arguments. A value of 0 is set when ADS 11 does not request VP 20 vehicle-mode. If VCIB 40 receives a Vehicle Mode Command with a value-0 set, the vehicle-mode at that time is maintained. Value-1 is set when the autonomous driving mode is requested from ADS 11 (Request For Autonomy). In other words, Vehicle Mode Command in which the value-1 is set is required to shift from the manual mode to the autonomous driving mode. Value-2 is a Deactivation Request that is set when a manual mode is requested from ADS 11. That is, Vehicle Mode Command in which the value-2 is set is required to shift from the autonomous driving mode to the manual mode.

In the vehicle 1, by transmitting a signal indicating the state of the vehicle mode from VCIB 40 to ADS 11 according to a predetermined API, the state of the vehicle mode of VP 20 is notified to ADS 11. Vehicle mode state may take on any of the values 0 and 1. The value 0 is set when the vehicle mode is the manual mode. The value 1 is set when the vehicle mode is the autonomous driving mode. When VP 20 is activated (Power mode status is Wake or Driving Mode), the vehicular mode starts from the manual mode. That is, the initial state of the vehicle mode is set to “manual mode”.

In the vehicle 1, according to a predetermined API, VCIB 40 transmits, to ADS 11, a signal indicating a ready state of automation of VP 20, thereby notifying ADS 11 of whether or not VP 20 can be shifted to the autonomous driving mode. Readiness for autonomization can have any of the values 0, 1, and 3. A value of 0 is set when the autonomous driving mode is not ready (Not Ready For Autonomous Mode). Value-1 is set when the autonomous driving mode is ready (Ready For Autonomous Mode). The value 3 is set if the state has not yet been determined. Value-3 means Invalid.

Referring back to FIG. 3, the transitions between the modes will be described in detail. The transition a indicates a transition from the manual mode to the automatic operation mode. In the manual mode, when the first condition is satisfied, the vehicle mode transitions from the manual mode to the automatic driving mode. The first condition includes the following conditions (1) to (4). The first condition is satisfied when all of the following conditions (1) to (4) are satisfied. The first condition is not satisfied when any of the following conditions (1) to (4) is not satisfied.

(1) ADK 10 is authenticated by VCIB 40. (2) Condition where Power mode status signal is Drive. (3) Conditions that Readiness for autonomization is “Auto-ready (Ready For Autonomous Mode)”. (4) Provided that Vehicle Mode Command is “Request For Autonomy”.

The transition b indicates a transition from the automatic operation mode to the manual mode. In the autonomous driving mode, when the second condition that Vehicle Mode Command is “Deactivation Request” is satisfied, the vehicle mode transitions from the autonomous driving mode to the manual mode.

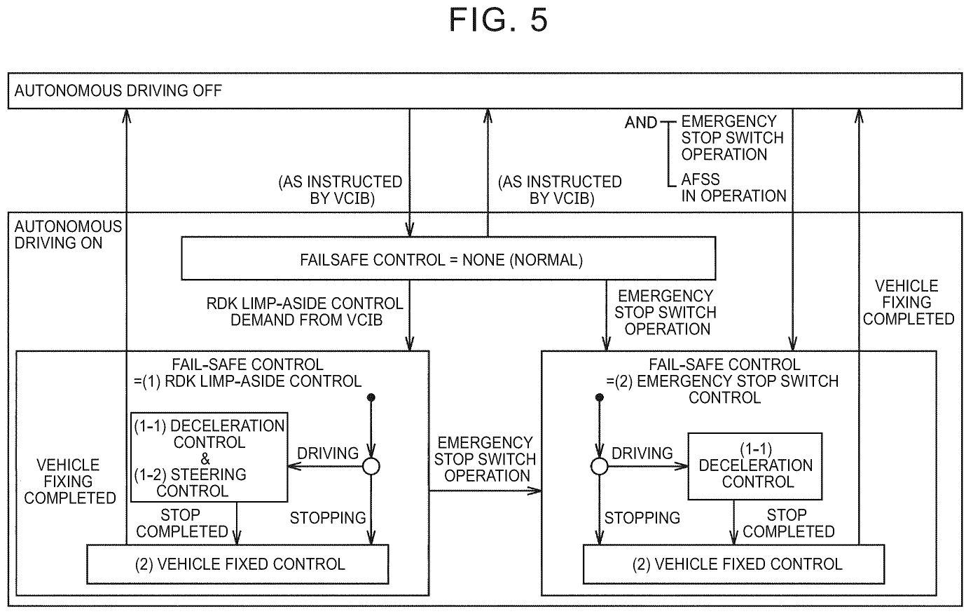

FIG. 5 is a diagram illustrating a state transition diagram of an integrated control manager 31 when the emergency-stop switch 39 is operated. Referring to FIG. 5, in a normal state, the state of the integrated control manager 31 transitions between the state of the autonomous driving OFF (manual driving mode) and the state (normal state) in which the fail-safe control is not performed in the autonomous driving ON (automatic driving mode) according to an instruction from VCIB 40.

Emergency Stop System in case of ADK Failure (AFSS) is an emergency-stop of VP 20 in the event of ADK 10 failure. In the state of the autonomous driving OFF, when the operation signal indicating that the emergency stop switch 39 has been operated is input to the integrated control manager 31 and AFSS is in operation, the state of the integrated control manager 31 shifts from the state of the autonomous driving OFF to the state in which the autonomous driving ON and the fail-safe control are (2) the emergency stop switch control.

When an operation signal indicating that the emergency stop switch 39 has been operated is input to the integrated control manager 31 in a state in which the autonomous driving ON and the fail-safe control are not performed, the state of the integrated control manager 31 shifts from a state in which the autonomous driving ON and the fail-safe control are not performed to a state in which the autonomous driving ON and the fail-safe control are (2) the emergency stop switch control.

When the autonomous driving ON and the fail-safe control are (2) emergency-stop-switch control, when the vehicle is traveling, the integrated control manager 31 executes the deceleration control, and when the vehicle is stopped, or when the vehicle is stopped by the deceleration control, the integrated control manager 31 executes the vehicle-fixed control. The deceleration control is a control for decelerating VP 20 by reducing the driving force of the propulsion system 343 or braking by the brake system 32. Vehicle-fixed control is control to activate EPB system 341 or P-Lock system 342 so that the wheels of VP 20 are fixed. When the vehicle-fixed control is completed, the state of the integrated control manager 31 shifts to the state of the autonomous driving OFF. Incidentally, when the state of the autonomous driving OFF is shifted by operating the emergency-stop switch 39, the transition to the state of the autonomous driving ON while VP 20 remains in the state of being activated is prohibited, VP 20 is once the state is not activated, if it can be started normally without the effect of a defect such as ADK 10, the transition to the state of the autonomous driving ON is permitted.

As described above, the processor of the integrated control manager 31 prohibits the transition from the state of the autonomous driving ON (autonomous driving mode) to the autonomous driving OFF (manual driving mode) provided that VP 20 is not stopped (the vehicle speed is higher than 0 km/h). Further, when the emergency-stop switch 39 is operated, the processor of the integrated control manager 31 transitions from the state of the autonomous driving ON (automatic driving mode) to the state of the autonomous driving OFF (manual driving mode) by the processor of the integrated control manager 31 on condition that VP 20 is not moved (here, the state in which the wheels of VP 20 are fixed). In addition, when shifting to the state of the autonomous driving OFF (manual driving mode), the transition to the autonomous driving ON is permitted by the processor of the integrated control manager 31 on condition that VP 20 is started from the state in which it is not started.

Control similar to the control performed when the emergency-stop-switch 39 is operated is conventionally performed in Remote Driving Kit (RDK of VCIB and the limp-aside control. RDK is a system in which an operator remotely controls the operation of a VP 20 instead of ADK 10. RDK linker side control is a control for appropriately stopping the vehicles 1 automatically when the control of RDK fails.

When the command from RDK becomes unavailable, VCIB 40 transmits a request for RDK linker side control to the integrated control manager 31. In the state in which the autonomous driving ON and the fail-safe control are not performed, the state of the integrated control manager 31 shifts from the state in which the autonomous driving ON and the fail-safe control are not performed to the state in which the autonomous driving ON and the fail-safe control are VCIB 40 and the state in which RDK rip-aside control is performed (1) when the request for RDK rip-aside control is transmitted to the integrated control manager 31.

When the autonomous driving ON and the fail-safe control are (1) RDK rip-side control, when the vehicle is traveling, the integrated control manager 31 executes the deceleration control and the steering control, and when the vehicle is stopping, or when the vehicle is stopped by the deceleration control and the stop control, the integrated control manager 31 executes the vehicle-fixed control. The deceleration control and the vehicle fixing control are the same as those described above. The steering control is a control that controls the steering system 33 to direct VP 20 to an appropriate location. When the vehicle-fixed control is completed, the state of the integrated control manager 31 shifts to the state of the autonomous driving OFF.

When an operation signal indicating that the emergency stop switch 39 has been operated is input to the integrated control manager 31 in a state where the autonomous driving ON and the fail-safe control are (1) RDK rip-side control, the state of the integrated control manager 31 shifts from a state where the autonomous driving ON and the fail-safe control are (1) RDK rip-side control to a state where the autonomous driving ON and the fail-safe control are (2) the emergency stop switch control. When the autonomous driving ON and the fail-safe control are (2) emergency-stop-switch control, the same control as described above is executed.

As described above, when the command from RDK becomes unavailable, the processor of the integrated control manager 31 transitions from the state of the autonomous driving ON (autonomous driving mode) to the state of the autonomous driving OFF (manual driving mode) on condition that VP 20 is not moved (here, the state in which the wheels of VP 20 are fixed). Further, when the emergency stop switch 39 is operated when the command from RDK becomes unavailable, the state of the autonomous driving OFF (manual driving mode) is shifted from the state of the autonomous driving ON (automatic driving mode) by the processor of the integrated control manager 31 on condition that VP 20 is not moved (in this case, the state in which VP 20 wheels are fixed).

The process performed by the processor of the integrated control manager 31 described above may be executed in cooperation with a processor of VCIB 41, 42, or may be executed by another processor.

The embodiments disclosed herein should be considered to be exemplary and not restrictive in all respects. It is intended that the scope of the disclosure be defined by the appended claims rather than the description of the embodiments described above, and that all changes within the meaning and range of equivalency of the claims be embraced therein.

What is claimed is:

1. A vehicle control device connected between an autonomous driving system and a vehicle platform that performs autonomous driving according to an instruction from the autonomous driving system, comprising:
a memory that stores a program that includes a predetermined application program interface (API) defined for each signal; and
a processor that controls the vehicle platform according to the instruction from the autonomous driving system by executing the program, wherein:
the vehicle control device includes a manual driving mode and an autonomous driving mode as vehicle modes;
the vehicle platform is capable of
receiving a manual driving operation in the manual driving mode, and
receiving a driving instruction from the autonomous driving system in the autonomous driving mode; and
the processor prohibits a transition from the autonomous driving mode to the manual driving mode on condition that the vehicle platform is not stopped.

2. The vehicle control device according to claim 1, wherein the processor transitions from the autonomous driving mode to the manual driving mode on condition that the vehicle platform has become immobile when an emergency stop switch is operated.

3. The vehicle control device according to claim 2, wherein the processor permits a transition to the autonomous driving mode on condition that the vehicle platform is activated from a state of being not activated when a transition is made to the manual driving mode.

4. The vehicle control device according to claim 2, wherein:
the vehicle platform is further capable of autonomous driving according to an instruction from a remote driving system; and
the processor
controls the vehicle platform according to the instruction from the remote driving system by executing the program, and
transitions from the autonomous driving mode to the manual driving mode on condition that the vehicle platform has become immobile when the processor is unable to receive the instruction from the remote driving system.

5. The vehicle control device according to claim 4, wherein the processor transitions from the autonomous driving mode to the manual driving mode on condition that the vehicle platform has become immobile when the emergency stop switch is operated when the processor is unable to receive the instruction from the remote driving system.
